(19) United States
(12) Patent Application Publication
(10) Pub. No.: US 2023/0119982 A1
(43) Pub. Date: Apr. 20, 2023

(54) METHOD FOR PERFORMING BRAKE DISC CLEANING OF A VEHICLE

(71) Applicant: Volvo Car Corporation, Göteborg (SE)

(72) Inventors: Henrik Fridén, Göteborg (SE); Derong Yang, Göteborg (SE)

(21) Appl. No.: 17/960,163

(22) Filed: Oct. 5, 2022

(30) Foreign Application Priority Data
Oct. 15, 2021 (EP) 21 202 930.0

(51) Int. Cl. B60T 8/172

(52) U.S. Cl. CPC B60T 8/172; B60T 2270/608

(57) ABSTRACT

A method for performing brake disc cleaning of an at least partially electrically driven vehicle including a brake system with at least one friction brake, the surface of which can be brought into contact with a corresponding brake disc, the method includes: determining an upcoming brake event by using at least vehicle-ahead information, predicting a needed deceleration level of an ego-vehicle by using the vehicle-ahead information, and carrying out a brake disc cleaning of the friction brake only in case the needed deceleration level of the ego-vehicle in the upcoming brake event is predicted as being above a predefined value.

### CROSS-REFERENCE TO RELATED APPLICATION

The present disclosure claims the benefit of priority of co-pending European Patent Application No. 21 202 930.0, filed on Oct. 15, 2021, and entitled “METHOD FOR PERFORMING BRAKE DISC CLEANING OF A VEHICLE,” the contents of which are incorporated in full by reference herein.

### TECHNICAL FIELD

The present disclosure relates to a method for performing brake disc cleaning of an at least partially electrically driven vehicle, a computer program element configured to carry out the method and an at least partially electrically driven electric vehicle including a control unit configured to carry out the method.

### BACKGROUND

BEV (Battery Electric Vehicle) and PHEV (Plug-in Hybrid Electric Vehicle) cars with sizable electric machines see very little use of friction brakes since regenerative braking is prioritized and will cover most braking needs. When the requested deceleration reaches a certain level, part of the braking will be carried out by the friction brake.

Since hard braking is relatively seldom in the everyday driving, the friction brake is thus not sufficiently used, which results in rust at cold and damp brake discs.

Rust on brake discs will lead to significantly lower brake performance and thus unwanted longer brake distance. Another side effect is unpleasant noise at very low speeds (such as parking maneuvers), where friction brakes are still used, and even when brakes are not engaged.

Disc clean function is adopted in many EVs (Electric Vehicles) today by applying only friction brakes so that the cumulative sum of each brake event temperature rise is reached at the desired level, e.g. 100 degrees C. In this way, the brake disc rust problem can be mitigated. However, in this case, no/less recuperation is possible.

### SUMMARY

Today, there is no specific selection of brake events when it comes to disc cleaning. The nominal way is to use friction brakes at regular intervals, even if some of these include low brake energy and are of little use. All brake events will be subject to friction brake application as soon as the disc clean function is activated. This strategy is very energy ineffective, specifically when considering the sharp demand of longer range in BEVs.

There may, therefore, be a need to provide an improved method for performing brake disc cleaning of an at least partially electrically driven vehicle.

The problem is at least partially solved or alleviated by the subject matter of the present disclosure.

According to a first aspect, there is provided a method for performing brake disc cleaning of an at least partially electrically driven vehicle (ego-vehicle, host vehicle, own vehicle) including a brake system with at least one friction brake. A surface of the friction brake can be brought into contact with a corresponding brake disc. The method includes, not necessarily in this order:
Step S1: determining an upcoming brake event of the at least partially electrically driven vehicle by using at least vehicle-ahead information of a vehicle ahead.
Step S2: predicting a needed deceleration level of the at least partially electrically driven vehicle by using the vehicle-ahead information.
Step S3: carrying out a brake disc cleaning of the friction brake of the at least partially electrically driven vehicle only in case the needed deceleration level of the at least partially electrically driven vehicle in the upcoming brake event is predicted as being above a predefined value.

Hence, there is provided a smarter, e.g. more energy efficient, method for brake disc cleaning.

In an example, the vehicle-ahead information may include at least one of a number of conditions such as a time gap between the vehicle and the vehicle ahead, a predicted deceleration needed of the vehicle and a brake energy anticipated of the vehicle, etc., which is used for assessing braking conditions of the vehicle, i.e. for predicting a needed deceleration level of the vehicle. Therefore, vehicle-ahead information can be gathered by using several units of the vehicle used for observation of the environment, e.g. cameras, radar sensors, sensors for determining acceleration etc.

In an example, further information may be combined with the vehicle-ahead information for determining an upcoming brake event of the at least partially electrically driven vehicle (in the following ego-vehicle). This further information includes at least one of an adaptive regenerative braking force of the ego-vehicle and driver behavior information of the ego-vehicle such as actual pedal position. An adaptive regenerative braking function can be used as information source in order to indicate a potential level (force) of braking needed.

If the needed deceleration level of the ego-vehicle can be predicted to be above a certain value in an upcoming brake event of the ego-vehicle, thus gaining high brake energy, the brake disc cleaning can be carried out only at this type of brake event so that an unnecessary use of friction brakes can be minimized.

Further, in an example, the prediction of the needed deceleration level of the ego-vehicle may be carried out by determining a safety distance to the vehicle ahead, and/or calculating a corresponding regeneration brake force of the ego-vehicle, and/or determining a required braking force of the ego-vehicle based on the vehicle mass and/or an estimated road load, and/or determining a required brake energy and/or brake power of the ego-vehicle.

Determining a safety distance d to the vehicle ahead can be done by multiplying the time gap t_{gap}between the ego-vehicle and the vehicle ahead with the actual velocity v_{ego} of the ego-vehicle:

d=t_{gap}*v_{ego}
The time gap t_{gap} is calculated by a look-up-table, which depends on the ego-vehicle's actual speed, i.e. velocity v_{ego}.

For calculating an adaptive regeneration brake force of the ego-vehicle, the acceleration as needed to get zero relative velocity between the ego-vehicle and the vehicle ahead within a safety distance d when approaching the vehicle ahead is calculated by:

$$a = \frac{{v}_{ahead}^{2} - {v}_{e g o}^{2}}{2 d} > {a}_{pred} [ \frac{m}{{s}^{2}} ]$$

where:
υ_{ahead}: velocity of the vehicle ahead,
α: acceleration needed to get zero relative velocity between the ego-vehicle and the vehicle ahead, and
α_{pred}: predicted acceleration needed for activating brake disc cleaning of the ego-vehicle.

Hence, the acceleration a_{pred} is the acceleration needed for activating brake disc cleaning.

Determining a required braking force F_{brake}. of the ego-vehicle based on the vehicle mass mass and an estimated road load F_{roadload,} which is only estimated by a vehicle motion sensor such as an acceleration sensor etc., can be done by calculating:

F_{brake}=mass*a+F_{roadload}

The roadload can be calculated using a set of constants that are multiplied with the vehicle speed v both linear and squared: F_rl=c1+c2*v+c3* v\hat{ }2.

The needed brake energy E_{brake} of the ego-vehicle depends on the brake disc temperature model readily available for each vehicle and can be determined by:

$${E}_{b r a k e} = \frac{mass * ( {v}_{ahead}^{2} - {v}_{ego}^{2} )}{2} + {F}_{roadload} * d > {E}_{r e q} [ J ]$$

where:
E_{req}: predicted brake energy needed for brake disc cleaning of the ego-vehicle.

The needed brake power P_{brake} of the ego-vehicle is calculated by:

P_{brake}=F_{brake}*r_{W}*ω_{wheel}>P_{req} [kW]

where:
r_{W}: effective wheel radius,
ω_{wheel}: deceleration when braking, and
P_{req}: required brake power by the driver.

Further, in an example, a brake event of the ego-vehicle may be triggered when at least one, some or all of the following conditions are fulfilled:
the regeneration brake force of the ego-vehicle exceeds a predetermined level and/or rate,
a determined speed difference between the ego-vehicle and the vehicle ahead exceeds a predetermined speed,
an accelerator pedal release rate of the ego-vehicle exceeds a predetermined value, and
a driver requested brake torque of the ego-vehicle exceeds a predetermined value.

In case a one pedal drive is applicable for the ego-vehicle, at least one of the following conditions may also need to be fulfilled:
an accelerator pedal position of the ego-vehicle is below a predetermined value, and
a driver requested brake torque rate of the ego-vehicle exceeds a predetermined value.

In another example, a computer program element is suggested, being configured to carry out a method as described above, when executed by a processor.

In another example, an at least partially electrically driven electric vehicle is suggested, including one or more units configured to acquire vehicle-ahead information, one or more units configured to acquire ego-vehicle information, and at least one control unit configured to carry out the method as described above.

The ego-vehicle information may at least include a pedal status and/or brake information and/or a regeneration brake force of the ego-vehicle.

### BRIEF DESCRIPTION OF THE DRAWINGS

Exemplary examples of the disclosure will be described in the following with reference to the following drawings.

FIG. 1 shows a schematic diagram of an exemplary example of the method for performing brake disc cleaning.

FIG. 2 shows an abstract diagram of measurements of an adaptive regeneration force function of an exemplary example of the method for performing brake disc cleaning.

FIG. 3 shows steps of the method for performing brake disc cleaning of an exemplary example.

The figures are merely schematic representations and serve only to illustrate examples of the disclosure. Identical or equivalent elements are in principle provided with the same reference signs.

### DESCRIPTION OF EMBODIMENTS

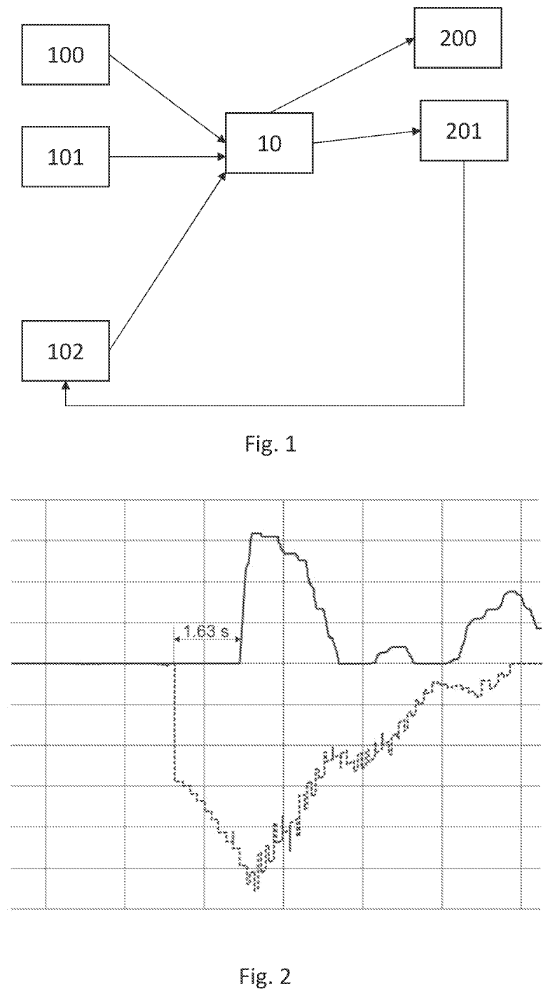

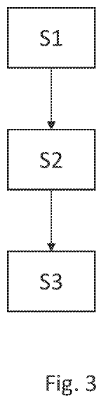

FIG. 1 shows a schematic diagram of an exemplary example of the method for performing brake disc cleaning. Here, information is shown that is needed in order to carry out the prediction of the deceleration level in order to decide, whether a brake disc cleaning is to be done or not.

As can be seen, information is collected in a central module 10, which can process the information and also instruct the braking system 200, 201. The braking system 200, 201 is indicated as brake control module 200 for friction brakes, of which the brake discs need to be cleaned e.g. from rust, and an electric motor unit 201, which is responsible for regeneration braking. In order for the central module 10 to instruct the braking module 200, 201, information from units 100 for environmental observation such as cameras, radar and other sensors, as well as driver behavior information from unit 101 and needed brake energy from the brake disc model 102 of the vehicle are necessary.

Driver behavior information is mainly the status of the acceleration and brake pedals or from the single pedal, being adapted for accelerating and braking in case of a one pedal drive.

When all necessary information is available, the central module 10 calculates the predicted brake force (in N) and converts it into energy (in J). This energy is compared with needed brake energy (in J) for the upcoming brake event. Then, a level for friction brake torque as well as for regeneration brake torque is calculated.

As soon as the accelerator pedal is released or the brake pedal is pressed (in one pedal configuration only as soon as the pedal is released in a predetermined position), the request for applying the respective torques is sent to the modules 200 and 201 for acting accordingly, thus activating brake disc cleaning.

In one example, the following conditions need to be fulfilled to send the request:
adaptive regeneration force has an absolute level of 1500N and a rate of >300 N/s,
speed difference between ego-vehicle and vehicle ahead is >10 km/h,
accelerator pedal release rate is >X %/s and accelerator pedal position is <Y % (in one pedal drive), where X and Y are predefined values depending on the vehicle and its configuration, and
driver requested brake torque is >V Nm and driver requested brake torque rate is >W Nm/s (in one pedal drive), where V and W are predefined values depending on the vehicle and its configuration.

In FIG. 2, an abstract diagram of measurements of an adaptive regeneration force function of an exemplary example of the method for performing brake disc cleaning is shown. Here, the possible need to brake was registered (indicated by the dotted graph) about 1.63 seconds before the driver requested brake force (indicated with the rising flank of the continuous line). As can be seen, the release rate of accelerator pedal or driver brake request rise rate can be used as a hint/trigger of upcoming high deceleration demand, and thus prepare to engage friction brakes primarily in order to clean brake discs.

With the suggested method, it is possible to minimize the activation of disc cleaning application, by predicting the use of friction brake at upcoming brake events. Only in case a needed deceleration level of the vehicle is predicted as high enough (exceeding a predefined value) and thus high brake energy is expected in an upcoming brake event, the brake disc cleaning is carried out. Hence, the unnecessary use of friction brakes can be minimized.

Other variations to the disclosed examples can be understood and effected by those skilled in the art in practicing the claimed invention, from the study of the drawings, the disclosure, and the appended claims. In the claims the word “comprising” does not exclude other elements or steps and the indefinite article “a” or “an” does not exclude a plurality. A single processor or other unit may fulfill the functions of several items or steps recited in the claims. The mere fact that certain measures are recited in mutually different dependent claims does not indicate that a combination of these measures cannot be used to advantage. A computer program may be stored/distributed on a suitable non-transitory computer-readable medium such as an optical storage medium or a solid-state medium supplied together with or as part of other hardware, including a processor and a memory, but may also be distributed in other forms, such as via the Internet or other wired or wireless telecommunication systems. Any reference signs in the claims should not be construed as limiting the scope of the claims.

1. A method for performing brake disc cleaning of an at least partially electrically driven vehicle comprising a brake system with at least one friction brake, a surface of the friction brake brought into contact with a corresponding brake disc, the method comprising:
determining an upcoming brake event of the at least partially electrically driven vehicle by using at least vehicle-ahead information of a vehicle ahead,
predicting a needed deceleration level of the at least partially electrically driven vehicle by using the vehicle-ahead information, and
carrying out the brake disc cleaning of the friction brake of the at least partially electrically driven vehicle only in case the needed deceleration level of the at least partially electrically driven vehicle in the upcoming brake event is predicted as being above a predefined value.

2. The method according to claim 1, the vehicle-ahead information comprising at least one of a time gap to the vehicle ahead, a predicted deceleration needed and a brake energy anticipated.

3. The method according to claim 1, further information comprising at least one of an adaptive regenerative braking force and a driver behavior information being combined with the vehicle-ahead information.

4. The method according to claim 1, the prediction of the needed deceleration level of the at least partially electrically driven vehicle being carried out by:
determining a safety distance to the vehicle ahead,
calculating an adaptive regeneration brake force,
determining a required braking force based on the mass of the at least partially electrically driven vehicle and an estimated road load, and
determining a required brake energy and brake power.

5. The method according to claim 1, the brake event being triggered when at least one of the following conditions is fulfilled:
the adaptive regeneration brake force exceeds a predetermined level and/or rate,
a determined speed difference between the at least partially electrically driven vehicle and the vehicle ahead exceeds a predetermined speed,
an accelerator pedal release rate exceeds a predetermined value, and
a driver requested brake torque exceeds a predetermined value.

6. The method according to claim 1, in case a one-pedal-drive is applicable, at least one of the following conditions needs to be fulfilled:
the adaptive regeneration brake force exceeds a predetermined level and/or rate,
a determined speed difference between the at least partially electrically driven vehicle and the vehicle ahead exceeds a predetermined speed,
an accelerator pedal position is below a predetermined value, and
a driver requested brake torque rate exceeds a predetermined value.

7. A non-transitory computer-readable medium comprising instructions stored in a memory and executed by a processor to carry out steps comprising:
for performing brake disc cleaning of an at least partially electrically driven vehicle comprising a brake system with at least one friction brake, a surface of the friction brake brought into contact with a corresponding brake disc,
determining an upcoming brake event of the at least partially electrically driven vehicle by using at least vehicle-ahead information of a vehicle ahead,
predicting a needed deceleration level of the at least partially electrically driven vehicle by using the vehicle-ahead information, and
carrying out the brake disc cleaning of the friction brake of the at least partially electrically driven vehicle only in case the needed deceleration level of the at least partially electrically driven vehicle in the upcoming brake event is predicted as being above a predefined value.

8. An at least partially electrically driven electric vehicle, comprising:
a brake system with at least one friction brake, a surface of the friction brake brought into contact with a corresponding brake disc,
one or more units configured to acquire vehicle-ahead information,
one or more units configured to acquire vehicle information of the at least partially electrically driven vehicle, and
at least one control unit configured to:
for performing brake disc cleaning,
determining an upcoming brake event of the at least partially electrically driven vehicle by using at least vehicle-ahead information of a vehicle ahead,
predicting a needed deceleration level of the at least partially electrically driven vehicle by using the vehicle-ahead information, and
carrying out the brake disc cleaning of the friction brake of the at least partially electrically driven vehicle only in case the needed deceleration level of the at least partially electrically driven vehicle in the upcoming brake event is predicted as being above a predefined value.
